(19) United States
(12) Patent Application Publication
(10) Pub. No.: US 2003/0017083 A1
(43) Pub. Date: Jan. 23, 2003

(54) Positioning aid for liquid handling devices

(75) Inventors: Sebastian Pobering, Erfurt (DE); Uwe Naumann, Jena (DE); Thomas Moore, Drackendorf (DE)

Correspondence Address: Gerald H. Kiel, Esq., REED SMITH, LLP, 375 Park Avenue, New York, NY, 10152-1799, US

(73) Assignee: CyBio Instrument GmbH

(21) Appl. No.: 10/172,555

(22) Filed: Jun. 13, 2002

(30) Foreign Application Priority Data
Jul. 17, 2001 (DE) 101 34 702.2

(51) Int. Cl. B01L 9/00

(52) U.S. Cl. 422/104; 422/99

(57) ABSTRACT

A positioning aid for liquid handling devices with a horizontally movable holding device for adapter and microtitration plate is disclosed. The holding device has a flexible tube extending in a closed channel and compressed air can be applied to the tube. The channel has, at least in the area of sliding pins which are arranged so as to be pretensioned by springs, widened portions which widen in the opposite direction to that of the spring, so that the sliding pins remain in a rest position when the tube is in the pressureless state so as to enable manipulation of the adapter and microtitration plate without friction, but, when compressed air is applied, occupy a clamping position in such a way that the tube fills out the widened portions so that the sliding pins contact the microtitration plate without play and the microtitration plate, in turn, contacts the stops of the adapter which are located across from the sliding pins, and the adapter contacts the fixed stops of the holding device without play.

### CROSS-REFERENCE TO RELATED APPLICATIONS

This application claims priority of German application No. 101 34 702.2, filed Jul. 17, 2001, the complete disclosure of which is hereby incorporated by reference.

### BACKGROUND OF THE INVENTION

a) Field of the Invention

The invention is directed to a positioning aid for liquid handling devices.

b) Description of the Related Art

Two-dimensional multiple-vessel systems for synthesis and analysis have been adopted in many areas of laboratory technique. Aside from the known microtitration plates, simple plane plates with a two-dimensional grid of hydrophobic and hydrophilic areas for very small volumes of liquid have also recently come into use. The variety of plates with respect to material characteristics, surface characteristics and optical transmission characteristics is enormous. The quantity of reaction vessels or reaction volumes present on a plate, at least, has become accepted. In this connection, either 96, 384 or 1563 of these are arranged on a plate in a grid shape with 8, 16 or 32 reaction vessels in one direction and 12, 24 or 48 reaction vessels in the other direction. The spacing of the wells or cavities is 9 mm, 4.5 mm or 2.25 mm, respectively. Unfortunately, the rapid development of microtitration plate technology and the fact that it is conceived for a great many different uses has not permitted any strict standardization. Accordingly, it is not uncommon for microtitration plates to be produced from different materials (e.g., polystyrene and polypropylene) on one and the same injection molding tool, which has resulted in different dimensioning of the plates due to the very different shrinkage characteristics of these two materials. Also, for this reason, particularly for plates with 384 cavities and certainly for plates with 1536 small cavities, it is necessary to undertake steps in order that the liquid handling devices and optical measurement devices hit the center of the respective cavities insofar as the plates are simply inserted in the usual all-purpose plate holders. This is especially true when this insertion of plates is carried out by means of simple automatic handling devices. Therefore, it is common in a great many optical measurement instruments with integrated X-Y tables—or microtitration plate readers, as they are called—to slide the plates into a corner by means of additional driving means or simple spring mechanisms and to move to the plate-specific cavity positions exactly relative to the measurement channel in accordance with the type of plate that is inserted by means of a correction table which is stored in the control software. Naturally, an essential prerequisite for this method is the existence of an X-Y table which, in keeping with their nature, is present in single-channel measurement instruments for microtitration plates. Other devices, as well as the liquid handling systems of the present applicant, have adapters which are specially produced for the respective types of plates in order to compensate for these differences in dimensions. This method is very simple and is also possible without the motor-driven X-Y correction described above; but, as a result, the microtitration plate must have mechanical play relative to the adapter and the adapter must, in turn, have mechanical play relative to its receptacle, since the plate and the adapter are automatically inserted in the receptacle without forces exceeding their own weights. For exact positioning of a large number of liquid handling channels dispensing in a noncontacting manner and arranged linearly relative to the microtitration plate and at right angles to the horizontal movement direction, it is necessary to eliminate this mechanical play.

### OBJECT AND SUMMARY OF THE INVENTION

It is the primary object of the invention to provide a positioning aid for liquid handling devices which can overcome the above-described disadvantages of the prior art.

According to the invention, this object is met in a positioning aid for liquid handling devices with a horizontally movable holding device for adapter and microtitration plate in that the holding device has a flexible tube extending in a closed channel, compressed air can be applied to the tube, the channel has, at least in the area of sliding pins which are arranged so as to be pretensioned by springs, widened portions which widen in the opposite direction to that of the spring, in that the sliding pins remain in a neutral or rest position when the tube is in the pressureless state so as to enable manipulation of the adapter and microtitration plate without friction and, when compressed air is applied, occupy a clamping position in such a way that the tube fills out the widened portions so that the sliding pins contact the microtitration plate without play and the microtitration plate in turn contacts the stops of the adapter which are located across from the sliding pins and the adapter contacts the fixed stops of the holding device without play.

The invention will be described more fully with reference to an embodiment example.

### BRIEF DESCRIPTION OF THE DRAWINGS

In the drawings:

FIG. 1 shows a top view of the receptacle with adapter and microtitration plate;

FIG. 2 is a sectional view illustrating the position of the microtitration plate and the sliding pin in the pressureless state of the tube;

FIG. 3 is a sectional view illustrating the position of the microtitration plate and the sliding pin when compressed air is applied;

FIG. 4 is a sectional view of the positioning aid according to the invention in pressureless state; and

FIG. 5 shows a sectional view of the positioning aid according to the invention when pressure is applied.

### DESCRIPTION OF THE PREFERRED EMBODIMENTS

The receptacle 1 which is generally a component part of a horizontally movable plate transport system which moves the microtitration plate 2 between the individual work stations of a liquid handling system has stops 12 enabling an exact positioning of the adapter 3. The adapter 3 itself has stops 6 which ensure positioning of the microtitration plate 2 on the adapter 3. There is no defined position of the microtitration plate 2 in relation to the receptacle 1, since there must necessarily be play between the microtitration plate 2 and adapter 3 as well as between the adapter 2 and the receptacle 1 when the microtitration plate 2, with or without the adapter 3, is automatically set down or held. But this is achieved by the arrangement according to the invention in the following manner:

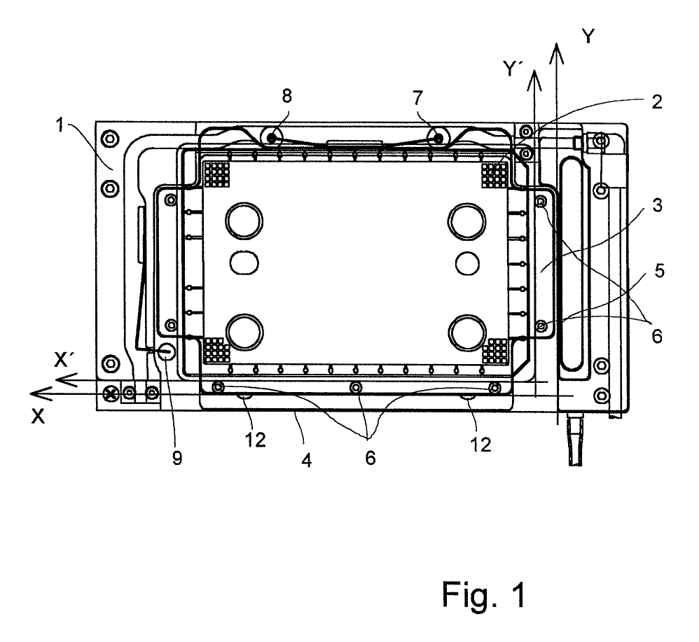

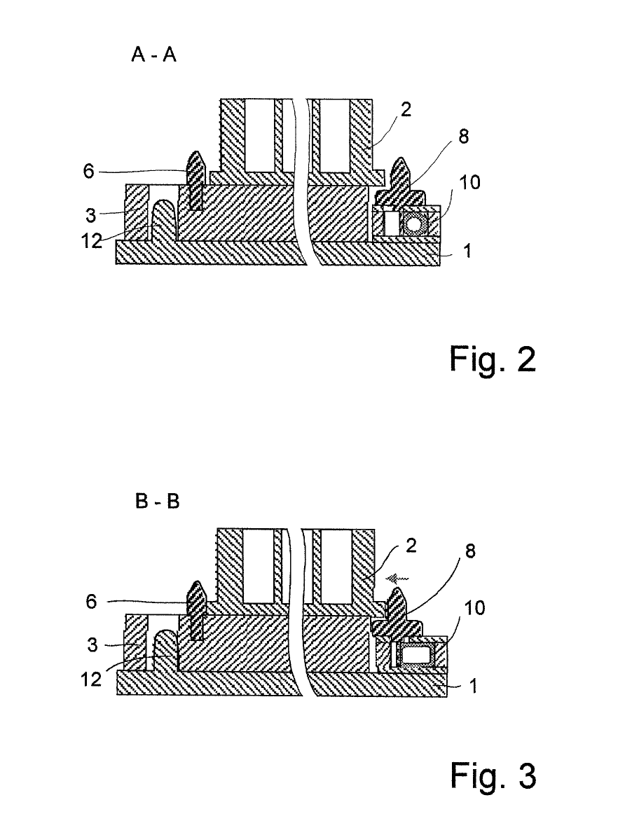

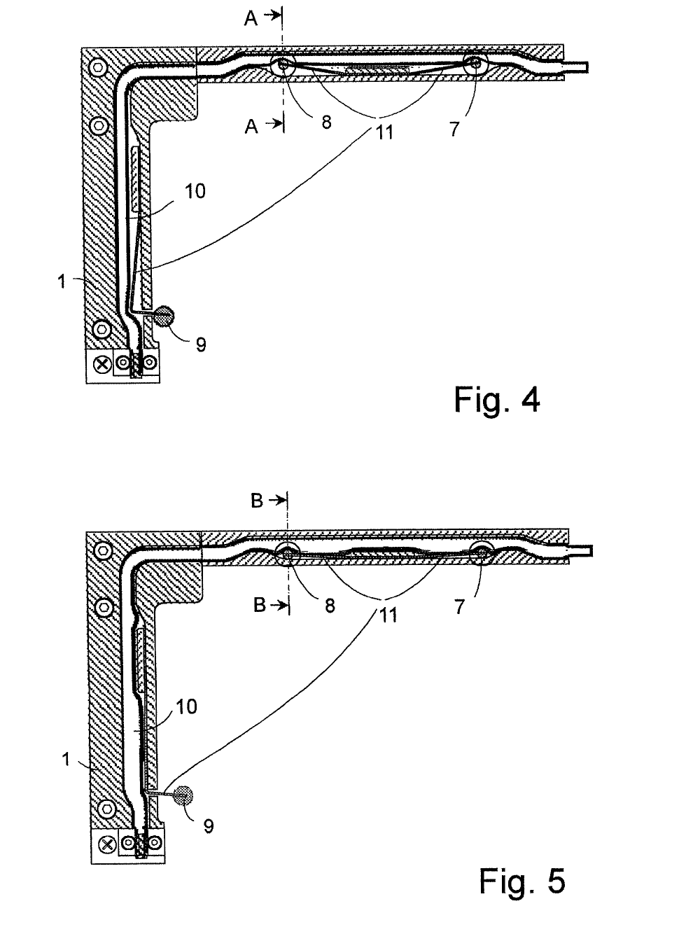

First, it should be noted that the adapter stops located on the receptacle 1 present a rectangular coordinate system. To illustrate this, the X-axis and Y-axis are shown in FIG. 1. As can clearly be seen, the stops can be X- or Y-stop edges 4 and 5 which extend in two dimensions along the axes or can be only point stops in the area of the adapter to be received. As can also be clearly seen from FIG. 1, the adapter 3 has stops 6. The stops 6 located closest to the X-axis describe a parallel X′-axis and the stops 6 located closest to the Y-axis describe a Y′-axis. Finally, FIG. 1 shows three sliding pins 7, 8, 9 to be associated with the receptacle 1. The sliding pins 7, 8, 9 are raised to the extent that they project over the adapter 3. When the adapter 3 is placed on the receptacle 1 by itself in the arrangement shown in FIG. 1, this adapter 3 lies between the X-stop edge 4, the Y-stop edge 5, the first sliding pin 7, the second sliding pin 8 and the third sliding pin 9 without play. Consequently, the microtitration plate 2 which is placed upon it lies without play between the stops 6 of the adapter 3, the first sliding pin 7, the second sliding pin 8 and the third sliding pin 9. FIG. 2 shows the typical state after the placement of the adapter 3 and microtitration plate 2. The air gap between the adapter 3 and the receptacle 1 and between the microtitration plate 2 and sliding pin 8 can be seen clearly in the drawing. For orientation of the microtitration plate 2, the flexible tube 10 which is in the pressureless state is provided with compressed air. The flexible tube 10 which is guided in a channel of the receptacle 1 (see FIG. 4 or FIG. 5) expands and, as shown in FIG. 3 for the second sliding pin 8, pushes the sliding pins 7, 8, 9 initially against the microtitration plate 2. The latter is then pushed against the stops 6 of the adapter 3 which are located across from the sliding pins 7, 8, 9, so that the microtitration plate 2 and adapter 3 are pushed jointly against the X-stop edge 4 and Y-stop edge 5. The microtitration plate 2 accordingly always occupies a reproducible position in relation to the receptacle 1. As can be seen in FIG. 4, every sliding pin 7, 8, 9 is connected with the receptacle 1 by a pretensioned leaf spring 11 in such a way that the sliding pin 7, 8, 9 occupies an end position remote of the plate, as shown in FIG. 2, during the pressureless phase of the flexible tube 10 which makes it possible to manipulate the microtitration plate 2 and adapter 3 without friction.

While the foregoing description and drawings represent the present invention, it will be obvious to those skilled in the art that various changes may be made therein without departing from the true spirit and scope of the present invention.

Reference Numbers:

1. holding device

2. microtitration plate

3. adapter

4. X-stop edge

5. Y-stop edge

6. stop

7. first sliding pin

8. second sliding pin

9. third sliding pin

10. tube

11. leaf spring

12. stop

What is claimed is:

1. A positioning aid for liquid handling devices comprising:
a horizontally movable holding device for adapter and microtitration plate;
said holding device having a flexible tube extending in a closed channel, wherein compressed air may be applied to the tube;
sliding pins being arranged to be pretensioned by springs;
said channel having, at least in an area where said sliding pins are arranged, widened portions which widen in opposite direction to that of the pretensioning spring; and
said sliding pins remaining in a rest position when the flexible tube is in a pressureless state so as to enable manipulation of the adapter and microtitration plate without friction and, when compressed air is applied, occupying a clamping position in such a way that the tube fills out the widened portions so that the sliding pins contact the microtitration plate without play and the microtitration plate in turn contacts stops of the adapter which are located opposite from said sliding pins and the adapter contacts the fixed stops of the holding device without play.

2. The positioning aid according to claim 1, wherein a sliding pin is arranged so as to adjoin the narrow side of the adapter and two sliding pins are arranged so as to adjoin the broad side.

3. The positioning aid according to claim 1, wherein every sliding pin is pretensioned by a leaf spring, and the leaf spring communicates with the inner wall of the channel at one end and communicates with the sliding pin at the other end such that the leaf spring exerts pressure against the tube and, in the pressureless state, moves the sliding pin into the initial position remote of the plate.
